(19) United States
(12) Patent Application Publication
(10) Pub. No.: US 2026/0124854 A1
(43) Pub. Date: May 7, 2026

(54) WHEEL MOUNTING STRUCTURE FOR VEHICLE

(71) Applicants: Hyundai Motor Company, Seoul (KR); Kia Corporation, Seoul (KR); Seohan Innobility Co., Ltd., Jincheon-gun (KR)

(72) Inventors: Ju Ho KIM, Hwaseong-Si (KR); Eun Sik KIM, Hwaseong-Si (KR); Hyun Soo KIM, Hwaseong-Si (KR); Young Seung YU, Hwaseong-Si (KR); Ki Jeong KIM, Hwaseong-Si (KR)

(73) Assignees: Hyundai Motor Company, Seoul (KR); Kia Corporation, Seoul (KR); Seohan Innobility Co., Ltd., Jincheon-gun (KR)

(21) Appl. No.: 19/201,550

(22) Filed: May 7, 2025

(30) Foreign Application Priority Data
Nov. 6, 2024 (KR) 10-2024-0156397

(51) Int. Cl. B60B 3/16

(52) U.S. Cl. CPC B60B 3/16; B60B 2900/3318

(57) ABSTRACT

A wheel mounting structure for a vehicle is disclosed. The wheel mounting structure includes a wheel hub mounted, at a center portion thereof, with a center boss protruding in an axial direction, a wheel fitted around the center boss at an internal diameter portion of the wheel, a displacement transfer member engaged to the center boss and selectively movable in an outward radial direction of the center boss, and a pressing ring mounted at the wheel and configured to press the wheel toward the wheel hub by displacement of the displacement transfer member.

### CROSS-REFERENCE TO RELATED APPLICATION

The present application claims priority to Korean Patent Application No. 10-2024-0156397 filed on Nov. 6, 2024, the entire contents of which is incorporated herein for all purposes by this reference.

### BACKGROUND OF THE PRESENT DISCLOSURE

### Field of the Present Disclosure

The present disclosure relates to technology for mounting a wheel of a vehicle to a wheel hub.

### Description of Related Art

A vehicle is configured to transmit drive force to tires thereof on a road surface, and accordingly, has a structure configured to mount each tire to a wheel and to mount the wheel to the vehicle, to mount the tire to the vehicle.

The wheel is mounted to a wheel hub of the vehicle. For stable power transmission performance and better durability of the vehicle, a firm mounting structure is required between the wheel and the wheel hub.

In conventional cases, a structure configured to fix a wheel to a wheel hub using a plurality of hub bolts and a plurality of wheel nuts is widely used. This structure provides very strong coupling and high durability.

However, the wheel mounting structure using the plurality of hub bolts and the plurality of wheel nuts has drawbacks in that a relatively long time to replace a wheel is consumed, and the appearance of the wheel mounting structure is somewhat poor.

In keeping with recent increase in popularity of high-performance vehicles and recent advances in motor sports, a further reduced time to replace the wheel and a more aesthetically pleasing and elegant wheel appearance are required.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a wheel mounting structure for a vehicle which is configured for greatly reducing a wheel replacement time and effectively preventing theft of a wheel while being advantageous in terms of formation of an aesthetically pleasing and elegant wheel appearance.

Objects of the present disclosure are not limited to the above-described object, and other objects of the present disclosure not yet described will be more clearly understood by those skilled in the art from the following detailed description.

In accordance with an aspect of the present disclosure, the above and other objects may be accomplished by the provision of a wheel mounting structure for a vehicle including a wheel hub provided, at a center portion thereof, with a center boss protruding in an axial direction, a wheel fitted around the center boss at an internal diameter portion of the wheel, a displacement transfer member engaged to the center boss and selectively movable in an outward radial direction of the center boss, and a pressing ring provided at the wheel and configured to press the wheel toward the wheel hub by displacement of the displacement transfer member.

The displacement transfer member may include a clamping ball inserted into a cage hole formed through the center boss in a radial direction of the center boss thereof.

The cage hole of the center boss may be formed in plural so that the cage holes are equally spaced apart along a circumferential direction of the center boss.

The clamping ball may be formed in plural so that the plurality of clamping balls is inserted into respective cage holes.

The cage hole may be constituted, at at least a portion thereof, by an inclined hole surface inclined with respect to a radial direction of the center boss to allow the clamping ball to protrude from a circumferential surface of the center boss while preventing the clamping ball from passing through the cage hole.

The wheel mounting structure may further include a slider provided to be linearly slidable within the center boss in the axial direction, and a rotating driver engaged to the slider and configured to generate an axial linear displacement of the slider by rotation force externally supplied to the rotating driver.

An inclined slider surface may be formed at a circumferential surface of the slider to enable the clamping ball to be pressed in the outward radial direction of the center boss within the cage hole by the axial linear displacement of the slider with respect to the center boss.

The inclined slider surface may include a curved surface inclined nonlinearly with respect to the axial direction.

A center cap may be provided at the center boss to seal an end portion of the center boss.

The rotating driver may include a center bolt threadedly coupled to the slider while extending through the center cap.

The slider may be supported by a spring to be elastically supported against the center cap.

A hub cavity configured to reduce a mass of the wheel hub may be provided at the wheel hub so that the hub cavity communicates with an internal space of the center boss.

A spring seat supporting the spring may be provided between the hub cavity and the internal space of the center boss.

A step having a discontinuously-reduced diameter may be formed at the hub cavity to receive and support the spring seat.

The pressing ring may be provided with a wheel-side inclined surface inclined with respect to the axial direction to change a radial displacement of the clamping ball into an axial displacement.

The pressing ring may be press-fitted in the wheel to be fixed to the wheel, to press the internal diameter portion of the wheel in the axial direction.

At least one stud may be provided at the hub flange of the wheel hub so that the stud protrudes to be inserted into a wheel hub groove of the wheel.

The stud may include a stud bolt fastened to the hub flange, and a stud sleeve formed to contact with the wheel hub groove and to allow the stud bolt to extend therethrough. The stud sleeve may be formed of a material different from a material of the stud bolt.

In accordance with another aspect of the present disclosure, there is provided a wheel hub assembly for a vehicle including a hub flange including a flat surface perpendicular to an axial direction, a center boss protruding from the hub flange in the axial direction, a center cap fastened to an end portion of the center boss to seal the end portion of the center boss, a center bolt provided to extend through the center cap, a slider threadedly coupled to the center bolt and being linearly slidable in the center boss in the axial direction when the center bolt rotates, and a clamping ball provided to move in an outward radial direction of the center boss by a linear displacement of the slider.

A cage hole may be formed through the center boss to receive the clamping ball while allowing the clamping ball to protrude from the center boss in the outward radial direction of the center boss.

The cage hole may be formed in plural so that the cage holes are equally spaced apart along a circumferential direction of the center boss.

The cage hole may be constituted, at at least a portion thereof, by an inclined hole surface inclined with respect to a radial direction of the center boss to allow the clamping ball to protrude from the circumferential surface of the center boss while preventing the clamping ball from passing through the cage hole.

A spring may be provided between the slider and the wheel hub to elastically support the slider against the center cap by the spring.

In accordance with another aspect of the present disclosure, there is provided a wheel for a vehicle including an internal diameter portion configured to be fitted around a center boss protruding along a rotation center portion of a hub flange in an axial direction, to couple the wheel to a wheel hub including the center boss, the wheel hub further including a clamping ball provided at an circumferential surface of the center boss to protrude from the circumferential surface of the center boss, and a stud configured to be spaced apart from the center boss while protruding from the hub flange in the axial direction, a wheel hub groove provided an area surrounding the internal diameter portion to receive the stud, and a pressing ring configured to be pressed by the clamping ball to press the area surrounding the internal diameter portion toward the hub flange.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a partially-broken perspective view showing a wheel mounting structure for a vehicle according to an exemplary embodiment of the present disclosure;

FIG. 2 is a sectional view of an essential portion of FIG. 1;

FIG. 3 is an exploded perspective view of the essential portion of FIG. 1;

FIG. 4 is a sectional view of a wheel hub;

FIG. 5 is a detailed view of the essential portion of FIG. 1;

FIG. 6 is a view showing a state in which locking of a wheel is released; and

FIG. 7 is a view showing a locked state of the wheel.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In the following description of the exemplary embodiments of the present disclosure, a detailed description of known technologies incorporated herein will be omitted when it may obscure the subject matter of the exemplary embodiments of the present disclosure.

Furthermore, the exemplary embodiments of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in an exemplary embodiment of the present disclosure.

It will be understood that, although the terms “first”, “second”, etc. may be used herein to describe various elements, these elements should not be limited by these terms. These terms are only used to distinguish one element from another.

Unless clearly used otherwise, singular expressions include a plural meaning.

In the present specification, the term “comprising”, “including”, or the like, is intended to express the existence of the characteristic, the numeral, the step, the operation, the element, the portion, or the combination thereof, and does not exclude another characteristic, numeral, step, operation, element, portion, or any combination thereof, or any addition thereto.

Any number of components or a variety of components of any one of the configurations disclosed in the present disclosure may be included in the present disclosure. Such components may include any combination of characterized portions disclosed in the present disclosure, and may be arranged to constitute any one of various configurations disclosed in the present disclosure. Not only structures and arrangements of the components of the present disclosure, but also concepts as to use and operation thereof, may be applied not only to various exemplary embodiments discussed in the present disclosure, but also to various exemplary embodiments of any numbers and in any combinations. In the following description, various exemplary embodiments including various characterized parts having various arrangements will be described with reference to the accompanying drawings.

Hereinafter, various embodiments included in the present disclosure will be described in detail with reference to the accompanying drawings, and the same or similar elements are designated by the same reference numerals regardless of the numerals in the drawings and redundant description thereof will be omitted.

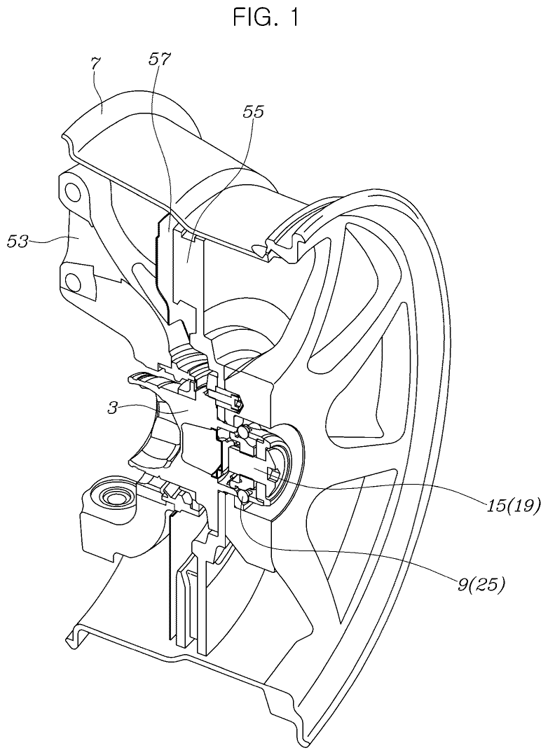

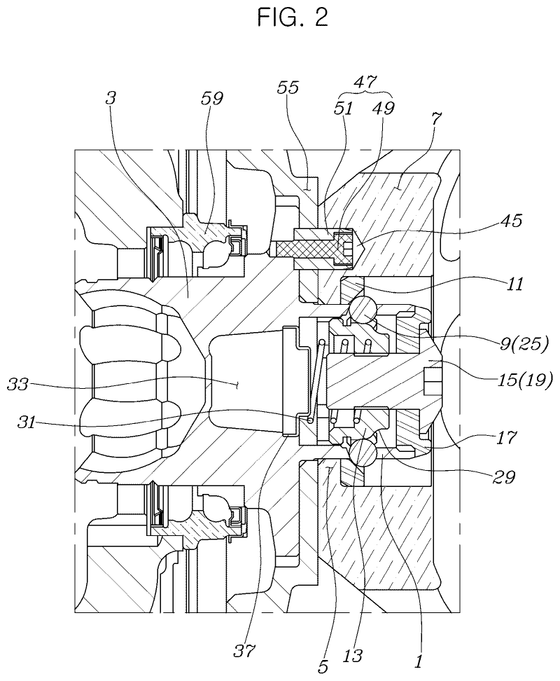

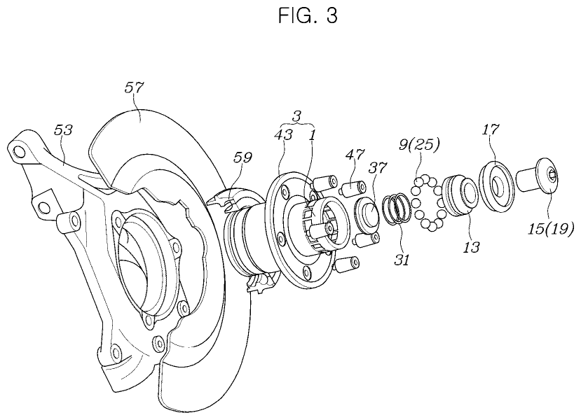

Referring to FIGS. 1 to 7, an exemplary embodiment of a wheel mounting structure for a vehicle in an exemplary embodiment of the present disclosure includes a wheel hub 3 mounted, at a center portion thereof, with a center boss 1 protruding in an axial direction, a wheel 7 fitted around the center boss 1 at an internal diameter portion 5 thereof, a displacement transfer member 9 configured to transfer an axial linear displacement of the displacement transfer member 1 in an outward radial direction of the center boss 1, and a pressing ring 11 mounted at the wheel 7 and configured to press the wheel 7 toward the wheel hub 3 by the displacement transferred by the displacement transfer member 9.

That is, the exemplary embodiment of the present disclosure is configured so that an axial linear displacement is generated within the center boss 1 in a state in which the internal diameter portion 5 of the wheel 7 is fitted around an external circumferential surface of the center boss 1 of the wheel hub 3, and, accordingly, the displacement transfer member 9 presses the pressing ring 11 toward the wheel hub 3, for fixing the wheel 7 to the wheel hub 3.

For reference, the “axial direction” means a rotation-axial direction of the wheel hub 3.

In the exemplary embodiment of the present disclosure, a slider 13, which is mounted to be linearly slidable within the center boss 1 in the axial direction, is provided, and a rotating driver 15, which is configured to generate an axial linear displacement of the slider 13 by rotation force externally supplied thereto, is also mounted.

Accordingly, when the rotating driver 15 is rotated by a tool or the like, the slider 13 generates an axial linear displacement to be supplied to the displacement transfer member 9 within the center boss 1.

In the exemplary embodiment of the present disclosure, a center cap 17 is mounted at the center boss 1 to seal an end portion of the center boss 1, and the rotating driver 15 includes a center bolt 19 threadedly coupled to the slider 13 while extending through the center cap 17.

Accordingly, when the center bolt 19 is rotated by a tool, the slider 13 threadedly coupled to the center bolt 19 generates a linear displacement while moving within the center boss 1 in the axial direction, and transfers the linear displacement to the displacement transfer member 9.

Thus, a task for mounting or separating the wheel 7 to or from the wheel hub 3 may be achieved only through rotation of the center bolt 19 in a predetermined direction or a reverse direction, and accordingly, easy and rapid wheel replacement may be secured.

Furthermore, since the above-described mounting and separation of the wheel 7 is achieved only through manipulation of the center bolt 19, it is unnecessary to fasten additional separate nuts and bolts or the like as the conventional way, and accordingly, there is an effect enabling the appearance of the wheel 7 to be aesthetically pleasing and elegant.

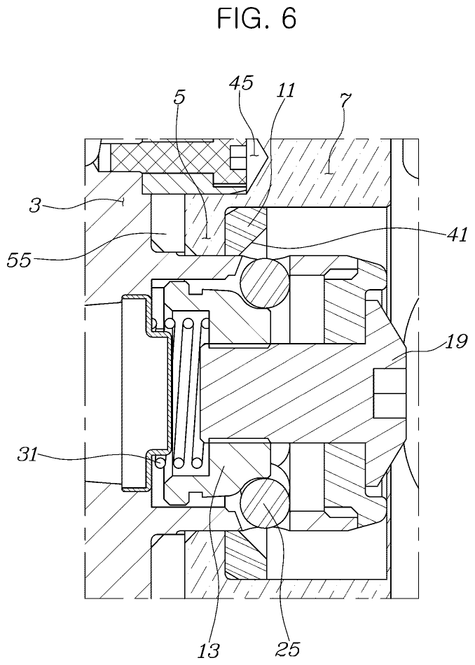

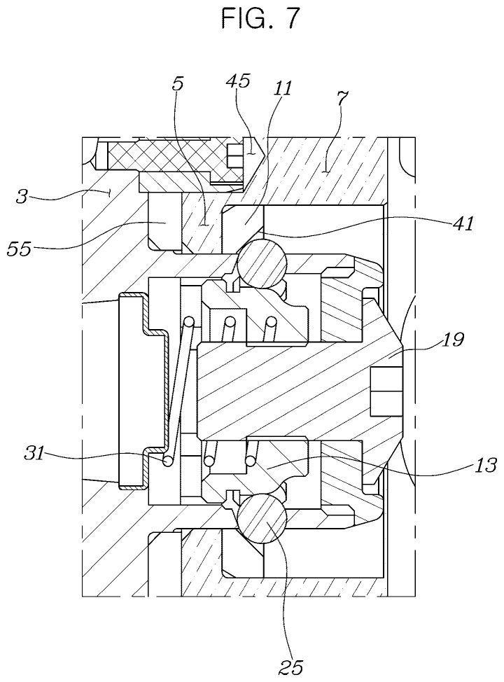

For reference, when the center bolt 19 is rotated in the predetermined direction in a state in which locking of the wheel 7 is released, as shown in FIG. 6, the slider 13 moves the displacement transfer member 9 in the outward radial direction of the center boss 1 while moving in a right direction in FIG. 7, and, accordingly, the pressing ring 11 is pressed by the displacement transfer member 9, thereby fixing the internal diameter portion 5 of the wheel 7 to the wheel hub 3.

When the center bolt 19 is rotated in the reverse direction in the above-described state, the slider 13 moves the displacement transfer member 9 in an inward radial direction of the center boss 1 while moving linearly in the axial direction toward the wheel hub 3, and accordingly, pressing of the pressing ring 11 is released. As a result, fixing of the wheel 7 is released from the wheel hub 3, and, accordingly, the wheel 7 may be separated from the wheel hub 3 as shown in FIG. 6.

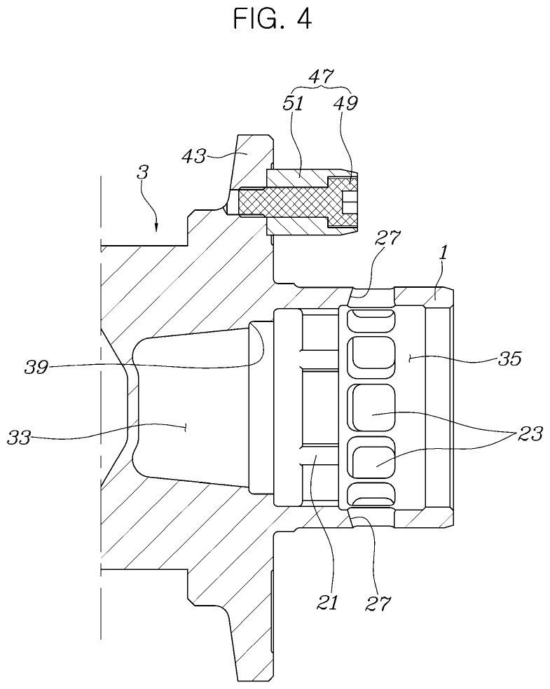

Meanwhile, referring to FIG. 4, serrations 21, which is configured to guide linear movement of the slider 13, are machined into an internal circumferential surface of the center boss 1 of the wheel hub 3 to enable the slider 13 to slide linearly through rotation of the center bolt 19 as described above.

Accordingly, a structure including grooves and protrusions corresponding to the serrations 21 of the center boss 1 is formed at an outer circumferential surface of the slider 13.

Meanwhile, in the exemplary embodiment of the present disclosure, the displacement transfer member 9 includes a clamping ball 25 inserted into a cage hole 23 formed through the center boss 1 in a radial direction of the center boss 1.

The cage hole 23 of the center boss 1 is formed in plural so that the cage holes 23 are equally spaced apart along a circumferential direction of the center boss 1. The clamping ball 25 is formed in plural so that the plurality of clamping balls 25 is inserted into respective cage holes 23. Accordingly, force of the clamping balls 25 acting on the pressing ring 11 may be uniformly exerted throughout the circumference of the center boss 1.

The cage hole 23 includes, at at least a portion thereof, an inclined hole surface 27 inclined with respect to a radial direction of the center boss 1 to allow the clamping ball 25 to partially protrude from the circumferential surface of the center boss 1 while preventing the clamping ball 25 from passing through the cage hole 23.

That is, the inclined hole surface 27 is formed to gradually reduce an opening area of the cage hole 23 as the inclined hole surface 27 extends outwards from a center portion of the center boss 1. As a result, a great protrusion amount of the clamping ball 25 protruding from the circumferential surface of the center boss 1 may be secured to sufficiently press the pressing ring 11 while preventing the clamping ball 25 from being completely separated from the cage hole 23. Thus, the replacement task for the wheel 7 or the like may be easily and simply achieved.

An inclined slider surface 29 is formed at the circumferential surface of the slider 13 to enable the clamping ball 25 to be pressed in the outward radial direction of the center boss 1 within the cage hole 23 by an axial linear displacement of the slider 13 with respect to the center boss 1.

In the exemplary embodiment of the present disclosure, the inclined slider surface 29 includes a curved surface inclined nonlinearly with respect to the axial direction.

Accordingly, the movement amount of the clamping ball 25 in the radial direction of the center boss 1 generated in accordance with the linear displacement of the slider 13 has nonlinear characteristics.

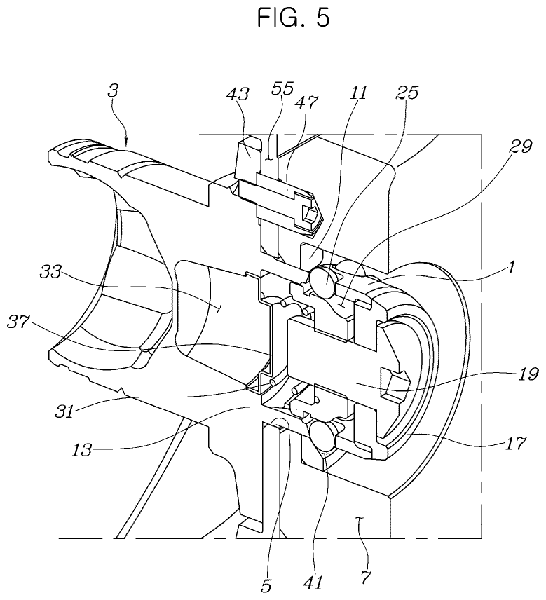

In the exemplary embodiment of the present disclosure, the inclined slider surface 29 includes a curved shape inclined to take an “S” shape, as shown in FIG. 5. Accordingly, even when the linear movement speed of the slider 13 is constant, the clamping ball 25 moves at a relatively higher speed in a period in which the clamping ball 25 presses the pressing ring 11 and a period in which the clamping ball 25 moves inwards from the circumferential surface of the center boss 1, as compared to the case in which the clamping ball 25 moves in a period other than the above-described periods.

Accordingly, it may be possible to rapidly achieve fixing and release of the wheel 7 while relatively reducing a rotation amount of the center bolt 19. Consequently, the replacement task for the wheel 7 or the like may be performed at a higher speed.

Meanwhile, the slider 13 may be supported by a spring 31 to be elastically supported against the center cap 17.

Elastic force of the spring 31 prevents the slider 13 from vibrating unnecessarily on the wheel hub 3 and the center bolt 19 and enables the slider 13 to form a stable linear displacement by rotation of the center bolt 19.

In the exemplary embodiment of the present disclosure, a hub cavity 33 to reduce the mass of the wheel hub 3 is formed at the wheel hub 3 so that the hub cavity 33 communicates with an internal space 35 of the center boss 1. A spring seat 37 to support the spring 31 is formed between the hub cavity 33 and the internal space 35 of the center boss 1.

Furthermore, a step 39 having a discontinuously-reduced diameter is formed at the hub cavity 33 to receive and support the spring seat 37. Accordingly, it may be possible to firmly and stably support the spring seat 37 without using a separate part.

Meanwhile, the pressing ring 11 is formed with a wheel-side inclined surface 41 inclined with respect to the axial direction to change a radial displacement of the clamping ball 25 into an axial displacement.

Furthermore, the pressing ring 11 is press-fitted in the wheel 7 to be fixed to the wheel 7, to press the internal diameter portion 5 of the wheel 7 in the axial direction.

That is, the pressing ring 11 is integrated with the wheel 7, and accordingly, it is unnecessary to separately handle the pressing ring 11 during replacement of the wheel 7. Accordingly, easy and rapid replacement of the wheel 7 may be secured. Furthermore, there is an advantage in that, when damage to the pressing ring 11 or the like occurs, only the pressing ring 11 may be easily replaced.

At least one stud 47 is mounted at the hub flange 43 of the wheel hub 3. The stud 67 protrudes to be inserted into a wheel hub groove 45 of the wheel 7.

Accordingly, relative rotation of the wheel 7 with respect to the wheel hub 3 caused by a torque acting between the wheel 7 and the wheel hub 3 may be structurally prevented.

As a result, a firm and stable assembly state between the wheel hub 3 and the wheel 7 may be secured and maintained.

Furthermore, since relative rotation between the wheel hub 3 and the wheel 7 is structurally reliably prevented and the stud 47 neither protrudes from nor is exposed outwardly of the wheel 7 in accordance with insertion of the stud 47 into the wheel hub groove 45, the appearance of the wheel 7 may be greatly enhanced.

The stud 47 may include a stud bolt 49 fastened to the hub flange 43, and a stud sleeve 51 formed to contact with the wheel hub groove 45 and to allow the stud bolt 49 to extend therethrough. The stud sleeve 51 may be formed of a material different from that of the stud bolt 49.

For example, the stud bolt 49 may be made of a steel material, and the stud sleeve 51 may be made of aluminum, an aluminum alloy, or the like.

The stud sleeve 51, which is made of an aluminum alloy, as described above, may provide thermal expansion characteristics similar to those of the wheel 7 made of a material identical or similar to the aluminum alloy, even for a thermal load transmitted thereto from the brake disc, etc. in a state in which the stud sleeve 51 is inserted into the wheel 7.

Accordingly, a firm and stable assembly state between the wheel 7 and the stud 47 may be maintained.

Meanwhile, a wheel hub assembly used in the wheel mounting structure for a vehicle according to an exemplary embodiment of the present disclosure includes a hub flange 43 configured to provide a flat surface perpendicular to an axial direction, a center boss 1 protruding from the hub flange 43 in the axial direction, a center cap 17 fastened to an end portion of the center boss 1 to seal the end portion of the center boss 1, a center bolt 19 mounted to extend through the center cap 17, a slider 13 threadedly coupled to the center bolt 19 and configured to linearly slide in the center boss 1 in the axial direction when the center bolt 19 rotates, and a clamping ball 25 mounted to move in an outward radial direction of the center boss 1 by a linear displacement of the slider 13.

A cage hole 23 formed through the center boss 1 in a radial direction to receive the clamping ball 25 while allowing the clamping ball 25 to protrude therefrom in the outward radial direction of the center boss 1. The cage hole 23 is formed in plural so that the cage holes 23 are equally spaced apart along a circumferential direction of the center boss 1.

The cage hole 23 is constituted, at at least a portion thereof, by an inclined hole surface 27 inclined with respect to a radial direction of the center boss 1 to allow the clamping ball 25 to protrude from the circumferential surface of the center boss 1 while preventing the clamping ball 25 from passing through the cage hole 23.

Furthermore, a spring 31 is mounted between the slider 13 and the wheel hub 3 to elastically support the slider 13 against the center cap 17.

Meanwhile, a wheel for a vehicle used in the above-described wheel mounting structure for a vehicle according to an exemplary embodiment of the present disclosure includes an internal diameter portion configured to be fitted around a center boss 1 protruding along a rotation center portion of a hub flange 43 in an axial direction, to couple the wheel to a wheel hub 3 including the center boss 1, the wheel hub 3 further including a clamping ball 25 mounted at an circumferential surface of the center boss 1 to protrude from the circumferential surface of the center boss 1, and a stud 47 configured to be spaced apart from the center boss 1 while protruding from the hub flange 43 in the axial direction. The wheel further includes a wheel hub groove 45 mounted an area surrounding the internal diameter portion 5 to receive the stud 47, and a pressing ring 11 configured to be pressed by the clamping ball 25 to press the area surrounding the internal diameter portion 5 toward the hub flange 43.

For reference, a knuckle 53, a brake disc 55, a brake disc cover 57, a wheel bearing 59, etc. which are not separately described, are also shown in the drawings.

As apparent from the above description, the present disclosure provides a wheel mounting structure for a vehicle which is configured for greatly reducing a wheel replacement time and effectively preventing theft of a wheel while being advantageous in terms of formation of an aesthetically pleasing and elegant wheel appearance.

Effects attainable in the present disclosure are not limited to the above-described effects, and other effects of the present disclosure not yet described will be more clearly understood by those skilled in the art from the above-described detailed description.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the embodiments are used for describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A wheel mounting structure for a vehicle, the wheel mounting structure comprising:
a wheel hub mounted, at a center portion thereof, with a center boss protruding in an axial direction;
a wheel fitted around the center boss at an internal diameter portion of the wheel;
a displacement transfer member engaged to the center boss and selectively movable in an outward radial direction of the center boss; and
a pressing ring mounted at the wheel and configured to press the wheel toward the wheel hub by displacement of the displacement transfer member.

2. The wheel mounting structure of claim 1,
wherein the displacement transfer member includes a clamping ball inserted into a cage hole formed through the center boss in a radial direction of the center boss,
wherein the cage hole of the center boss is formed in plural so that the plurality of cage holes are equally spaced apart along a circumferential direction of the center boss,
wherein the clamping ball is in plural so that the plurality of clamping balls is inserted into respective cage holes, and
wherein each cage hole includes, at at least a portion thereof, an inclined hole surface inclined with respect to the radial direction of the center boss to allow a corresponding clamping ball to protrude from a circumferential surface of the center boss while preventing the corresponding clamping ball from passing through a corresponding cage hole.

3. The wheel mounting structure of claim 2, further including:
a slider engaged to the clamping ball and mounted to be linearly slidable within the center boss in the axial direction; and
a rotating driver engaged to the slider and configured to generate an axial linear displacement of the slider by rotation force externally supplied to the rotating driver.

4. The wheel mounting structure of claim 3, wherein the slider includes an inclined slider surface formed at a circumferential surface of the slider to enable the clamping ball to be pressed in the outward radial direction of the center boss within the cage hole by the axial linear displacement of the slider with respect to the center boss.

5. The wheel mounting structure of claim 3, wherein the inclined slider surface includes a curved surface inclined nonlinearly with respect to the axial direction.

6. The wheel mounting structure of claim 3,
wherein a center cap is mounted at an end portion of the center boss to seal the end portion of the center boss, and
wherein the rotating driver includes a center bolt threadedly coupled to the slider while extending through the center cap.

7. The wheel mounting structure of claim 6, wherein, based on that the center bolt is rotated in a first direction, the slider moves the displacement transfer member in the outward radial direction of the center boss while moving linearly in the axial direction toward the wheel, and the displacement transfer member moving in the outward radial direction of the center boss presses the pressing ring toward the wheel hub, for fixing the wheel to the wheel hub.

8. The wheel mounting structure of claim 7, wherein, based on that the center bolt is rotated in a second direction, the slider moves the displacement transfer member in an inward radial direction of the center boss while moving linearly in the axial direction toward the wheel hub, for releasing the pressing of the pressing ring so that fixing of the wheel is released from the wheel hub.

9. The wheel mounting structure of claim 6, wherein the slider is supported by a spring to be elastically supported against the center cap.

10. The wheel mounting structure of claim 9,
wherein a hub cavity for reducing a mass of the wheel hub is formed at the wheel hub so that the hub cavity communicates with an internal space of the center boss, and
wherein a spring seat supporting the spring is formed between the hub cavity and the internal space of the center boss.

11. The wheel mounting structure of claim 10, wherein a step having a discontinuously-reduced diameter is formed at the hub cavity to receive and support the spring seat on the step.

12. The wheel mounting structure of claim 3,
wherein serrations are formed at an internal circumferential surface of the center boss of the wheel hub to guide axial linear movement of the slider along the serrations, and
wherein a structure including grooves and protrusions corresponding to the serrations of the center boss is formed at a circumferential surface of the slider and slidably engaged to the serrations.

13. The wheel mounting structure of claim 2, wherein the pressing ring includes a wheel-side inclined surface inclined with respect to the axial direction to change a radial displacement of the clamping ball into an axial displacement based on that the clamping ball contacts with the wheel-side inclined surface.

14. The wheel mounting structure of claim 13, wherein the pressing ring is press-fitted in the wheel to be fixed to the wheel, to press the internal diameter portion of the wheel in the axial direction.

15. The wheel mounting structure of claim 2,
wherein at least one stud is mounted at a hub flange of the wheel hub so that the at least one stud protrudes to be inserted into a wheel hub groove of the wheel, and
wherein the at least one stud includes:
a stud bolt connected to the hub flange; and
a stud sleeve formed to contact with the wheel hub groove and to allow the stud bolt to extend through the stud sleeve, the stud sleeve being formed of a material different from a material of the stud bolt.

16. A wheel hub assembly for a vehicle, the wheel hub assembly comprising:
a hub flange including a flat surface perpendicular to an axial direction;
a center boss protruding from the hub flange in the axial direction;
a center cap connected to an end portion of the center boss to seal the end portion of the center boss;
a center bolt mounted to extend through the center cap;
a slider threadedly coupled to the center bolt and being linearly slidable in the center boss in the axial direction based on that the center bolt rotates; and
a clamping ball mounted in the center boss to move in an outward radial direction of the center boss by a linear displacement of the slider.

17. The wheel hub assembly of claim 16,
wherein a cage hole is formed through the center boss to receive the clamping ball in the cage hole while allowing the clamping ball to protrude from the center boss in the outward radial direction of the center boss, and
wherein the cage hole is formed in plural so that the plurality of cage holes are equally spaced apart along a circumferential direction of the center boss.

18. The wheel hub assembly of claim 17, wherein the cage hole includes, at at least a portion thereof, an inclined hole surface inclined with respect to a radial direction of the center boss to allow the clamping ball to protrude from the circumferential surface of the center boss while preventing the clamping ball from passing through the cage hole.

19. The wheel hub assembly of claim 16, wherein a spring is mounted between the slider and a wheel hub to elastically support the slider against the center cap by the spring.

20. A wheel for a vehicle, the wheel comprising:
an internal diameter portion configured to be fitted around a center boss protruding along a rotation center portion of a hub flange in an axial direction, to couple the wheel to a wheel hub including the center boss, wherein the wheel hub further includes a clamping ball mounted at an circumferential surface of the center boss to protrude from the circumferential surface of the center boss and a stud configured to be spaced apart from the center boss while protruding from the hub flange in the axial direction;
a wheel hub groove formed at an area surrounding the internal diameter portion to receive the stud in the wheel hub groove; and
a pressing ring configured to be pressed by the clamping ball to press the area surrounding the internal diameter portion toward the hub flange.
